(19) United States
(12) Patent Application Publication
(10) Pub. No.: US 2026/0100670 A1
(43) Pub. Date: Apr. 9, 2026

(54) SUBMERSIBLE SOLAR INSTALLATION

(71) Applicant: Klaus Schuwerk, Berlin (DE)

(72) Inventors: Klaus Schuwerk, Berlin (DE); Leonhardt Matteo Schuwerk, Berlin (DE)

(73) Assignee: Klaus Schuwerk, Berlin (DE)

(21) Appl. No.: 19/415,842

(22) Filed: Dec. 11, 2025

Related U.S. Application Data
(63) Continuation of application No. PCT/EP2024/066345, filed on Jun. 13, 2024.

(30) Foreign Application Priority Data
Jun. 14, 2023 (DE) 10 2023 002 411.2

(51) Int. Cl. H02S 20/30; H02S 30/10; H02S 30/20

(52) U.S. Cl. CPC H02S 20/30; H02S 30/10; H02S 30/20

(57) ABSTRACT

A submersible solar installation is provided, the installation comprising a solar panel; at least one buoyancy body connected to the solar panel; wherein the solar panel and the at least one buoyancy body are designed to have a positive buoyancy at a water surface of a body of water; and a diving element adapted to subject the submersible solar installation to a negative buoyant force; wherein the at least one buoyancy body includes a first buoyancy body that is at least partially reversibly compressible.

### CROSS REFERENCE TO RELATED APPLICATIONS

This application is a continuation application of international patent application PCT/EP2024/066345, filed on Jun. 13, 2024, and designating the U.S., which claims priority to German patent application 10 2023 002 411.2, filed on Jun. 14, 2023, each of which are hereby incorporated by reference in their entireties.

### TECHNICAL FIELD

The disclosure can relate to a submersible solar installation with a device for achieving a floating state at a predetermined diving depth.

### BACKGROUND

Solar installations and optionally photovoltaic installations can reduce CO₂ emissions of humanity. However, one problem is the large land consumption for such installations.

Floating solar installations on artificial and natural lakes, as well as on the sea, provide an alternative. Artificial lakes are only available to a limited extent. In natural lakes, there are often concerns due to landscape protection. An unsolved problem with installations on the open sea is the survivability of storms accompanied by high waves.

The most widespread typology today for floating solar installations provides buoyancy bodies made of plastic on which conventional photovoltaic panels are mounted (e.g. U.S. Pat. No. 9,132,889 B2). Those systems are only suitable for protected or limited water surfaces such as lakes. Another typology uses the system of annular buoyancy bodies from fish farming with a PVC film stretched therein on which flexible photovoltaic panels are mounted. Those systems are not suitable for the open sea. Another typology uses a platform of solar modules on a metal structure with buoyancy bodies located underneath (e.g. WO 2022/135729 A1). The solar panels here have a distance of several meters from the water and thus form a surface exposed to wind. The system is also complex and material-intensive. Another typology provides for the mounting of solar panels directly on floating bodies made of aluminum (e.g. WO 2021/130283 A1). This system is only suitable for protected or limited water surfaces such as lakes or bays.

Those systems can have the disadvantage that they are not suitable for storms, for example storms on the open sea with high waves. In addition, the assembly and disassembly of those systems can be relatively complicated and therefore expensive with respect to the areas required for the production of electrical energy on the gigawatt scale.

### SUMMARY

A submersible solar installation is provided, the installation comprising a solar panel; at least one buoyancy body connected to the solar panel; wherein the solar panel and the at least one buoyancy body are designed to have a positive buoyancy at a water surface of a body of water; and a diving element adapted to subject the submersible solar installation to a negative buoyant force; wherein the at least one buoyancy body includes a first buoyancy body that is at least partially reversibly compressible.

### DESCRIPTION OF THE DRAWINGS

The drawings show the following:

FIG. 1 a perspective view of an exemplary, non-limiting implementation of the solar installation;

FIG. 2 a side sectional view of an exemplary, non-limiting implementation of the solar installation;

FIG. 3 a perspective view of a section of an exemplary, non-limiting implementation of the solar installation;

FIG. 4 a perspective view of a section of an exemplary, non-limiting implementation of the solar installation;

FIG. 5 a sectional view of an exemplary, non-limiting implementation of the solar installation;

FIG. 6 a perspective sectional view of an exemplary, non-limiting implementation of the solar installation;

FIG. 7 a sectional view of an exemplary, non-limiting implementation of the solar installation;

FIG. 8 a perspective sectional view of an exemplary, non-limiting implementation of the solar installation;

FIG. 9 a section through an exemplary, non-limiting implementation of the solar installation with a flexible and/or thin-film panel and a compressible buoyancy body;

FIG. 10 a perspective sectional view of an exemplary, non-limiting implementation of the solar installation with a flexible and/or thin-film panel and a compressible buoyancy body;

FIG. 11 a section through an exemplary, non-limiting implementation of the solar installation with a one-piece partially reversibly compressible buoyancy body;

FIG. 12 a view of an exemplary, non-limiting implementation of the transport and assembly system during the unfolding process at a water surface;

FIG. 13 a perspective view of an exemplary, non-limiting implementation of the transport and assembly system during movement by a crane system;

FIG. 14 a perspective view of an exemplary, non-limiting implementation of the transport and assembly system during the unfolding process at a water surface;

FIG. 15 a perspective view of an exemplary, non-limiting implementation of a diving element comprising a diving element designed as a winch;

FIG. 16 a perspective detailed view of an exemplary, non-limiting implementation of a diving element comprising a diving element designed as a winch, with the inspection cover removed;

FIG. 17 a perspective view of an exemplary, non-limiting implementation of the solar installation;

FIG. 18 a perspective view of a section of the underside of the solar installation according to an exemplary, non-limiting implementation; and

FIG. 19 a perspective view of a further section of the solar installation according to an exemplary, non-limiting implementation.

### DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

One possible object of the present disclosure can be to provide a solar installation that can withstand storms, optionally on bodies of water, for example storms on the open sea with high waves. A further object can be to provide a solar installation that can deliver increased energy yield. In addition, the disclosure can be intended to enable simple, efficient, and cost-effective transport, as well as assembly and disassembly of the solar installation.

The submersible solar installation can comprise a solar panel; at least one buoyancy body connected to the solar panel; wherein the solar panel and the at least one buoyancy body have a positive buoyancy at a water surface of a body of water; and a diving element adapted to subject the submersible solar installation to a negative buoyant force; wherein the at least one buoyancy body comprises a first buoyancy body that is at least partially reversibly compressible.

If the solar installation is brought to a predetermined diving depth, the first buoyancy body, the at least partially reversibly compressible buoyancy body, can be compressed to a predetermined volume due to the hydrostatic pressure. Optionally, a buoyancy body can be dimensioned with the following calculation formulas so that gravity and buoyant force are balanced at the predetermined diving depth and thus the solar installation can float at the predetermined diving depth. Floating can occur when the total buoyant force is approximately zero newtons. Approximately zero newtons within the meaning of the disclosure is optionally a positive or negative buoyant force of less than 100 N, more optionally 50 N, 40 N, 30 N, 20 N, 10 N, 5 N, 4 N, 3 N, 2 N, optionally less than 1 N.

A solar installation in the sense of this disclosure is optionally an installation that comprises one or more solar panels and is optionally intended for the production of electrical energy.

A solar panel in the sense of this disclosure is optionally an essentially flat device that is adapted to convert sunlight into electrical energy.

A reversibly compressible buoyancy body in the sense of this disclosure is optionally a body that essentially follows Boyle and Mariotte's law, i.e. its volume behaves inversely proportional to ambient pressure at constant temperature. A compressible buoyancy body can serve to influence the total buoyancy of the solar installation at predetermined diving depths in such a way that this can be advantageous for the disclosure. It can be advantageous if the solar installation floats at the surface and optionally floats at the predetermined diving depth.

An at least partially reversibly compressible buoyancy body in the sense of this disclosure is a buoyancy body that has a reversibly compressible portion and optionally an incompressible portion. An at least partially reversibly compressible buoyancy body can essentially follow Boyle and Mariotte's law up to a predetermined diving depth. From a predetermined water depth up to the maximum diving depth in intended use, the partially reversibly compressible buoyancy body can essentially no longer be compressed. It is clear that the transition from the compressible to the incompressible state can also be adjusted gradually, for example by using a less elastic material and/or geometry of the reversibly compressible buoyancy body. An at least partially compressible buoyancy body serves to influence the total buoyancy of the solar installation at predetermined diving depths in such a way that this can be advantageous for the disclosure.

At least partially reversibly compressible in the sense of this disclosure means that a buoyancy body can be either partially reversibly compressible or fully reversibly compressible.

An at least partially reversibly compressible buoyancy body can comprise a shell of which at least one section or the shell itself is adapted to be reversibly compressed at a certain pressure, which optionally prevails within the predetermined diving depth. The at least one section of the shell or the shell itself can be formed from a reversibly plastically deformable plastic material.

The predetermined diving depth can for example be between 5 and 50 meters, optionally between 10 and 40 meters, 15 and 30 meters, or 20 and 25 meters. A construction of the reversibly compressible buoyancy body or the partially reversibly compressible buoyancy body can be adapted for the predetermined diving depths. Thus, in a reversibly compressible buoyancy body and/or partially reversibly compressible buoyancy body, reversible compressibility or partial reversible compressibility occurs predominantly, e.g. and optionally over at least 50%, e.g. at least 60%, 70%, 80%, 90%, or at least 95% of the total volume of the reversibly compressible buoyancy body or the reversibly compressibly designed partial volume of the partially reversibly compressible buoyancy body, up to the predetermined diving depth. The compression of the total volume of the reversibly compressible buoyancy body or of the partial volume of the partially reversibly compressible buoyancy body can take place essentially linearly. For example, a reversibly compressible buoyancy body can be designed in such a way that its total volume is reversibly reduced by at least 60% when moving from the water surface to a predetermined diving depth of e.g. 20 meters.

An incompressible buoyancy body in the sense of this disclosure can be a body that essentially retains its volume when the ambient pressure changes, wherein the volume can be filled with a fluid or fluid mixture, e.g. air and/or water. One or more incompressible buoyancy bodies can serve to adjust the total buoyancy of the solar installation independently of the diving depth so that this can be advantageous for the disclosure. Incompressible buoyancy bodies can comprise buoys, such as buoyancy buoys or corner buoys, and diving bells. The incompressible buoyancy body can comprise a first device, e.g. a pump, wherein the first device is adapted to replace the fluid or fluid mixture, e.g. water against air or another gas or gas mixture, at least partially. The incompressible buoyancy body can further comprise a second device, e.g. one or more valves, wherein the second device is adapted to allow the entry of a fluid or fluid mixture, e.g. water, into the incompressible buoyancy body.

An incompressible buoyancy body can comprise a shell that is essentially not compressed or deformed at a certain pressure, which optionally prevails within the predetermined diving depth.

An essentially maintained volume of a buoyancy body in the sense of this disclosure is optionally the case when the volume of a body in the intended diving depth is compressed to not less than 90%, optionally not less than 95%, 96%, 97%, or 98%, optionally not less than 99% relative to the volume at atmospheric pressure.

Incompressibility in the sense of this disclosure means that the volume of a body can be considered constant despite a force or pressure change, e.g. due to a pressure increase by a factor of two. It is clear to the skilled person that incompressibility is only an idealizing assumption for simplified description of physical processes. In the sense of this disclosure, solids and liquids are considered incompressible, while gases are compressible.

The reversibly compressible buoyancy body or the partially compressible buoyancy body can contain a fluid space, usually an air space, to generate the positive buoyancy. The air space can contain atmospheric air as a compressible gas. Other gases or mixtures thereof can be contained, provided that these generate positive buoyancy in the volume of the reversibly compressible buoyancy body or partially compressible buoyancy body.

As reversibly compressible buoyancy body, for example, a flexible plastic material, e.g. an elastomer or a thermoplastic, can be used, which contains an air space. For example, the flexible plastic material can comprise a single or several air spaces. The flexible plastic material can for example comprise a pore structure.

In an exemplary, non-limiting implementation, the at least one compressible buoyancy body and an incompressible buoyancy body are two separate buoyancy bodies.

In a further exemplary, non-limiting implementation, the at least one reversibly compressible buoyancy body and an incompressible buoyancy body are part of a partially reversibly compressible buoyancy body, i.e. this partially compressible buoyancy body has a reversibly compressible and an incompressible portion.

In a further exemplary, non-limiting implementation, the partially reversibly compressible buoyancy body is a buoyancy body that can be compressed up to a certain pressure and thereafter is essentially no longer compressible. One exemplary, non-limiting implementation of this exemplary, non-limiting implementation can comprise a buoyancy body with a wholly or partially compressible outer shell, for example made of an elastomer, and a spaced incompressible but air-permeable core, for example made of solid open-pored aluminum foam or of a hollow metal body with small openings. A further example of this exemplary, non-limiting implementation is shown in FIG. 11: a profile is elastically compressible up to the point at which, for example, a free central web touches the opposite side and thus further compression is prevented. Decisive for the exemplary, non-limiting implementation with a partially compressible buoyancy body is the principle that the buoyancy body can be compressed to a certain extent and thereafter is essentially no longer compressible up to the intended diving depth. It is clear to the skilled person that further variants in addition to the two presented are possible.

In a further exemplary, non-limiting implementation, the incompressible buoyancy body and/or the compressible buoyancy body can at the same time form the frame of the solar panel.

In a further exemplary, non-limiting implementation, several solar panels can share a compressible and/or an incompressible and/or a partially compressible buoyancy body.

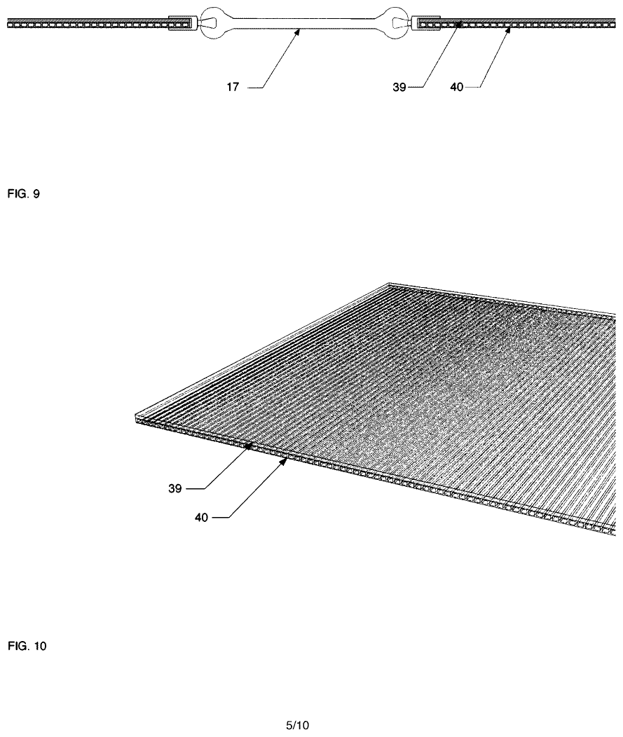

In a further exemplary, non-limiting implementation according to claim 1, the incompressible buoyancy body can be omitted, since the solar panel and the compressible buoyancy body together already have the ideal buoyancy at the surface of the body of water and at the predetermined diving depth. As shown in FIGS. 9 and 10, this can be the case for certain flexible and/or thin-film panels, since these, due to their lightweight construction, can inherently have little negative buoyant force. This exemplary, non-limiting implementation can have the advantage that the material usage is significantly reduced compared with a variant using glass-glass panels.

A negative buoyant force in the sense of this disclosure is a force with a direction opposite to the direction of the positive buoyant force.

In a further exemplary, non-limiting implementation, the solar panel and the buoyancy body or bodies can be arranged such that the entire solar panel is located below the water surface. This can, for example, be achieved by arranging at least a portion of the buoyancy body above the surface of the solar panel.

In a further exemplary, non-limiting implementation, the solar installation can have a desired positive or negative total buoyancy at a predetermined diving depth by choosing larger or smaller buoyancy bodies.

In a further exemplary, non-limiting implementation, the solar installation can comprise a plurality of solar panels which are arranged in an area, and the solar panels can be flexibly connected to one another.

In a further exemplary, non-limiting implementation, the solar installation can comprise a rope net which is connected to the at least one buoyancy body and the diving element, wherein optionally the force exerted by the diving element acts substantially uniformly on the at least one buoyancy body.

A substantially uniform action of a force from a diving element on a plurality of attachment points of the at least one buoyancy body in the sense of this disclosure element that, calculated under calm wind and wave conditions and with the diving element and the solar installation at a standstill, the smallest force and the largest force at the different attachment points optionally differ by less than 100%, more optionally by less than 50%, 40%, 30%, 20%, 10%, 5%, 4%, 3%, 2%, 1%, optionally do not differ. It is clear that the forces occurring in practice, caused for example by water waves or dynamic forces from actuating the diving element, can lead to significantly larger differences. Exemplary diving elements can comprise a pulling system which can be configured, for example, as a winch or winch installation.

A rope net in the sense of this disclosure can be an essentially planar rope construction which comprises at least one essentially catenary-shaped rope and on which in each case a plurality of straight hanging ropes can be attached for transmitting the forces. The underlying static concept corresponds to that of a suspension bridge.

Optionally, a rope net can be arranged parallel to the water surface. The rope net optionally comprises or consists of four or more catenary-shaped ropes which can optionally be connected at the corners of the solar installation, optionally via an incompressible buoyancy body, for example a buoy, to a diving element, and of a plurality of straight hanging ropes which are in each case connected at one end to the catenary-shaped rope and at the other end to the at least one solar panel. The rope net can ensure that the force from the diving element is introduced substantially uniformly into the entire edge of the solar panel field.

In a further exemplary, non-limiting implementation, the solar installation can comprise a pulling system and an anchoring, wherein a pulling system can be provided at four or more attachment points and is adapted to pull the solar installation to the predetermined diving depth.

An anchoring can hold the solar installation in position. There can be different possibilities for anchoring depending on the forces occurring and the nature of the bed of the body of water.

In a further exemplary, non-limiting implementation, the solar installation can additionally comprise a buoy which is connected to the pulling system and the rope net. The buoy can in this case constitute a buoyancy body which can be incompressible, compressible or partially compressible. When this buoy is pulled by the pulling system in the direction of the anchoring point on the bed of the body of water, it generates a buoyant force with a vector from the buoy vertically upwards. The pull of the pulling system simultaneously generates a further force with a vector from the buoy in the direction of the anchoring point. Using a parallelogram of forces, the resulting horizontal force can be determined with which the field of solar panels is held in position. By an appropriate choice of the type and size of the buoyancy body of the buoy, a favorable horizontal force can be set. A favorable horizontal force can, for example, be between 100,000 N and 1,000 N.

The buoy can also be integrated into the diving element or into other parts of the solar installation.

During submersion and surfacing or when the solar panels generate a positive or negative buoyancy, a resulting force with a direction other than the horizontal can also arise.

A solar installation in the sense of the present disclosure provides at least one compressible air space and can in this case comprise a solar panel; an incompressible buoyancy body; an elastic connection between the solar panels; a rope net; an anchoring system; a diving element; a buoy; an electrical cable connection; a solar charge controller; and a transformer.

The air space of a compressible or partially compressible buoyancy body can also be formed in part by non-movable and/or non-stretchable material. Further, only one section of the compressible buoyancy body can move and/or stretch, while the other section remains unmoved and/or unstretched. In doing so, the compressible buoyancy body can form a compressible air space and essentially follow Boyle-and Mariotte's law.

The exact physical conditions are set out below: With increasing hydrostatic pressure, the reversibly compressible buoyancy body is compressed, as a result of which the buoyancy of the installation in the sense of the present disclosure decreases. At a predetermined diving depth, the weight force of the solar installation can correspond to the weight force of the displaced water and the solar installation can float in accordance with Archimedes' principle. For the solar installation in the sense of the present disclosure, any desired buoyant force at the surface and any desired diving depth at which the installation floats can be determined. The necessary calculation methods are set out below. The resulting buoyant force F of a body in water is calculated as follows:

$$F = V \cdot {ρ}_{water} \cdot g - V \cdot {ρ}_{body} \cdot g , \qquad ( 1 )$$

where V is the volume of the body, p the bulk density and g the local acceleration due to gravity (≈9.81 N/kg).

In an exemplary, non-limiting implementation of the disclosure, the total buoyant force of the solar installation is divided into a fixed part (solar panel; incompressible buoyancy body) and into a variable part (reversibly compressible buoyancy body). At the water surface, the following applies:

$${F}_{total} = {F}_{fix} + {F}_{var} . \qquad ( 2 )$$

At the diving depth t (in meters), the following applies:

$${F}_{total} = {F}_{fix} + 1 / ( t / 10 + 1 ) \cdot {F}_{var} . \qquad ( 3 )$$

In a specific example, a glass-glass solar module can have a negative buoyancy of 250 N, an incompressible buoyancy body a buoyancy of 247.5 N, and a reversibly compressible buoyancy body at the water surface a buoyancy of 7.5 N. This yields at the water surface:

$${F}_{total} = - 2 \; 50 N + 247.5 N + 7.5 N = 5. N \qquad ( 4 )$$

At the diving depth t=20 m, the following applies:

$${F}_{total} = - 2 \; 50 N + 247.5 N + 1 / ( 20 / 10 + 1 ) \cdot 7.5 N = - 2.5 N + 2.5 N = 0. N . \qquad ( 5 )$$

That is, the solar module floats at the water surface and floats at a diving depth of 20 m.

In a further exemplary, non-limiting implementation, a partially reversibly compressible buoyancy body can be used. At the surface of the body of water, the following applies:

$${F}_{total} = {F}_{fix} + {F}_{var} . \qquad ( 6 )$$

Here, Fᵥₐᵣ is the proportion of the buoyant force of the flexible part of the partially reversibly compressible buoyancy body.

Up to a predetermined water depth x (in meters), at a diving depth t (in meters), the following applies:

$${F}_{total} = {F}_{fix} + 1 / ( t / 10 + 1 ) \cdot {F}_{var} . \qquad ( 7 )$$

From a predetermined water depth x or deeper, the following applies:

$${F}_{total} = {F}_{fix} + 1 / ( x / 10 + 1 ) \cdot {F}_{var} . \qquad ( 8 )$$

In a specific example, a glass-glass solar module can have a negative buoyancy of 250 N, an incompressible buoyancy body a buoyancy of 200 N, and a partially reversibly compressible buoyancy body at the water surface a buoyancy of 55 N. The partially reversibly compressible buoyancy body can in this case be designed so that it is maximally compressible to 10/11 of its initial volume, i.e. according to Boyle and Mariotte's law, has reached its minimum volume at a diving depth of one meter. Specifically, this partially compressible buoyancy body of the example shown can have at the water surface an air space of about 5,500 ml, of which 5,000 ml are in a rigid part and 500 ml of air are in a flexible part, and the parts are connected to each other via an opening. In this specific example, at the water surface the following applies:

$${F}_{t otal} = - 2 \; 50 N + 200 N + 55 N = 5 N . \qquad ( 9 )$$

At a diving depth of 1 m or deeper the following applies:

$${F}_{total} = - 2 \; 50 N + 200 N + 50 N = 0 N \qquad ( 10 )$$

That is, the solar module of the example floats at the water surface and floats at a diving depth of 1 m or deeper.

Further factors can also have an influence on buoyancy and are optionally taken into account when dimensioning the buoyancy bodies, optionally the minimum and maximum possible air pressure in the deployment area, the minimum and maximum possible water temperature in the deployment area, and the minimum and maximum possible density of the water in the deployment area, optionally in saline sea water.

An advantage of the disclosure can be that the solar installation can not only be pulled into the depth but can also easily be kept at a predetermined diving depth in order to withstand unfavorable climatic conditions such as storms. In the depth, optionally, no vertical force is required to hold the position of the solar installation. The solar installation can move with any water movements possibly present in the depth without problematic forces building up, analogous to a sail that moves with the wind or a manta ray that appears to glide weightlessly through the water.

As a result, a relatively small number of diving elements and anchorings may be required, optionally 1 diving element per 100 or more panels, optionally per 1,000 or more panels, optionally per 10,000 or more panels. The resulting fields of solar panels can therefore be very large, which has a favorable effect on the overall manufacturing costs of the solar installation.

The force of the pulling system that is required to pull the solar installation downward can be optimized by appropriately choosing the size of the buoyancy bodies. As a result, smaller and more cost-effective pulling systems can be used.

A further advantage of the disclosure can be that, in contrast to installations on land, the solar panels of the solar installation according to the disclosure are cooled via direct contact with the water and can thus provide an immediately higher energy yield of up to 15%.

In addition, the constant water tempering of the disclosure can have the advantage that the solar panels and their components degrade less over the years because large temperature fluctuations are avoided. The correspondingly longer service life of the installation can generate an additional energy gain of up to 20% compared with conventional solar installations.

The solar installation offers no attack surface for wind compared with conventional floating solar installations. A disaster such as the accident in 2019 at Yamakura Dam is thus prevented, even if the solar installation should be located at the water surface. If the installation is pulled into the depth, the risk is further reduced and at the same time the components of the solar installation are protected.

A further advantage can be that the solar installation according to the disclosure is suitable for prefabrication. This can significantly reduce total costs. A further advantage can be that assembly and disassembly can be carried out rationally and cost-effectively.

A further advantage of the disclosure can be that, in contrast to widespread floating solar installations, to land-based solar installations and to wind power installations, it is little visible. Already at a few hundred meters distance from the coast, it can be practically invisible due to its low profile. There are therefore relatively few concerns with regard to landscape protection.

A further advantage of the disclosure can be that the solar installation according to the disclosure can be constructed from materials that can be completely recycled after their planned deployment.

A further advantage can be that, due to its modularity and simple geometry, the solar installation can easily be cleaned with fully automatic cleaning robots.

An exemplary, non-limiting implementation of the disclosure, which represents a non-limiting example, is described in more detail below.

According to an exemplary, non-limiting implementation, a submersible solar installation 1 is provided. The submersible solar installation 1 can comprise a plurality of solar panels 16; a partially reversibly compressible buoyancy body 41 having an incompressible portion 23, a reversibly compressible portion 24, and an air-conducting connection 25; a flexible connection 17 between the solar panels, optionally consisting of an elastomer; an electrical connection 18; a solar charge controller; a voltage converter; a rope net 2; a buoy 3; a diving element 4; and an anchoring 6. The reversibly compressible portion 24 can, for example, consist of an elastomer, optionally silicone rubber with a wall thickness of 1 mm, and be formed such that, at a water depth of, for example, two meters, complete compression occurs. The diving element 4 can in this case comprise a steel cable 5; a diving element 26 designed as a winch; an electric motor 28; and batteries 27. Instead of the steel cable 5, ropes or textiles made of fibers based on polymers with a high molecular mass of, for example, 10⁶ mol g/mol or more, optionally ultra-high-molecular-weight polyethylene (PE-UHMW) of 2×10⁶ mol g/mol to 6×10₆ mol g/mol, can also be used.

The described exemplary, non-limiting implementation of the solar installation 1 can comprise a plurality of solar panels 16 which are connected to each other in an area along the side and longitudinal edges by a flexible connection 17. The plurality of solar panels 16 can be connected in the edge region by fastening elements 15 to the rope net 2. The rope net 2 can comprise four catenary-shaped ropes 13 which are optionally connected to four buoys 3 and a plurality of hanging ropes 14 which establish the connection between the catenary-shaped ropes 13 and the fastening elements 15. The rope net 2 ensures the uniform distribution of the application of force from the anchoring 6 and the diving element 4 to the plurality of solar panels 16.

The buoys 3 at the corner points of the solar installation 1 can in part comprise a reversibly compressible and in part an incompressible buoyancy body, whereby the buoyancy at the surface and at the desired diving depth can be predetermined by the calculation methods described above.

The diving element 4 can be flexibly connected to the buoy 3 and can, for example, consist of a diving element 26 designed as a conventional winch or standard winch for steel cables. In the described exemplary, non-limiting implementation, a steel cable 5 can be guided from the winch to a deflection pulley in the vicinity of the anchoring 6 and back to the winch, where it can be fastened to its housing, optionally made of corrosion-resistant coated steel. This can form a simple tackle that halves the forces on the winch. In addition, this allows the winch and the steel cable to be easily replaced without a diver being required.

The winch can be protected by a housing which can be open in the direction of the bottom of the body of water and thus, analogously to a diving bell, remains dry. The steel cable 5 can move freely through the opening. The air pressure in the winch system thereby adapts to the respective ambient pressure and there is no pressure load on the steel housing and the seal 29 of the inspection opening. The air volume in the steel housing can be calculated such that it can be correspondingly compressed without electrical and electronic components coming into contact with water.

The winch 26 can comprise an electric motor 28 which can be operated by batteries 27 that in turn can be charged by the solar panels. Control can be carried out via sonar transponders or via cable connections.

The anchoring 6 on the bottom of the body of water 11 can, in the case of a sandy bottom, be implemented by screw anchors. These and alternative anchoring methods for different bottoms can be used.

The solar installation 1 can be provided with all usual electrical connections that are required for proper functioning.

The intended electrical connections 18 can be pre-installed in the factory such that, for example, as in the example shown in FIG. 14, for every one hundred and eighty standard panels 31 that fit in a 40-foot transport container, only two commercially available watertight plug connections (positive and negative) are required. For this purpose, the panels can be applied to a frame 30 at the factory in a folded arrangement and provided with hanging ropes 32 and all required electrical connections 18. The panels can in this case be wired in series and in parallel in accordance with the design layout of the solar installation 1.

From a solar installation 1 according to the disclosure, a flexible electrical connection 7 can lead to a point held by a buoyancy body and an anchoring. Optionally, this point can be located halfway between the water surface and the intended maximum depth of the solar installation 1. From this point, a vertical electrical connection 8 can lead to the bottom of the body of water. From there, a ground cable 9 can be routed to an inverter and a voltage converter, possibly also to the shore if it is not too far away. Cables and technologies used in offshore wind projects and other renewable technologies on the open sea may be used.

A frame 30 in the sense of this disclosure is a static structure on which a plurality of solar panels can be arranged for the purpose of transport. The frame with the solar panels 31 arranged thereon can be adapted to be moved by a crane system 33. Optionally, a frame has one or more attachment points for attaching hanging ropes 32.

A container in the sense of this disclosure is a container adapted for transport into which the sub-frame with the solar panels arranged thereon can be placed and thus protected against damage during transport. Optionally, the container can be a 40-foot ISO container (40′ Open Top Container).

Folding in the sense of this disclosure can be folding together of a planar object according to the principle of the Leporello or zigzag folding.

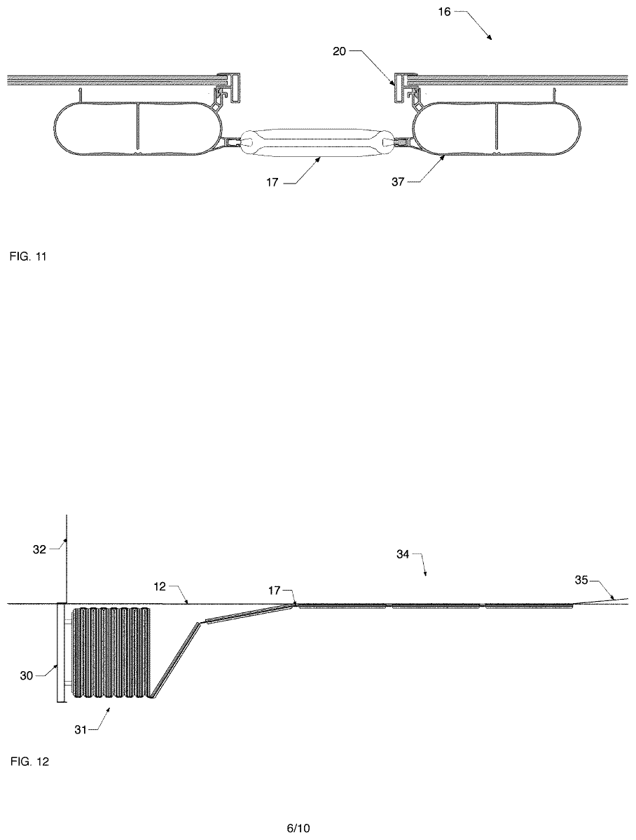

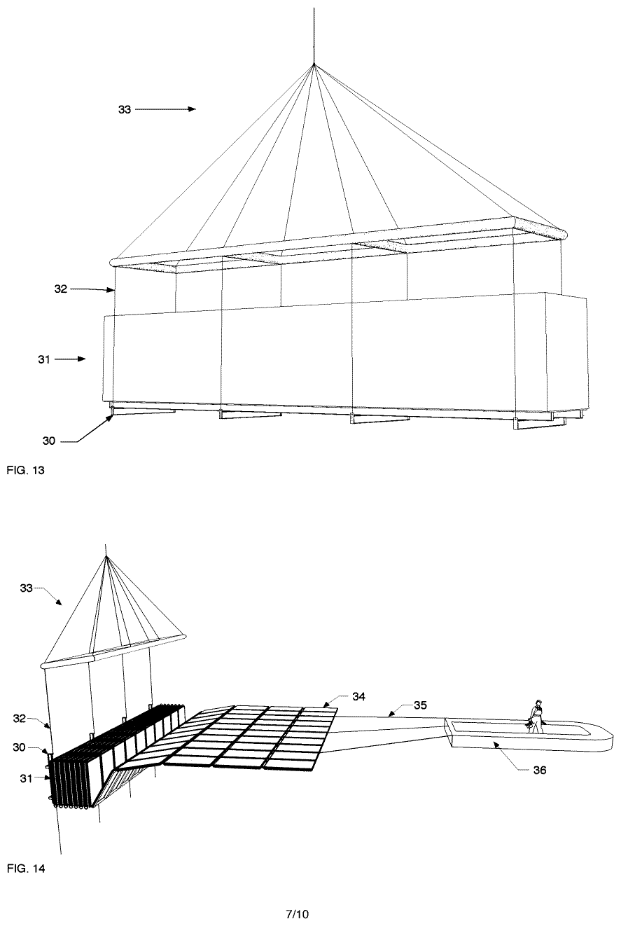

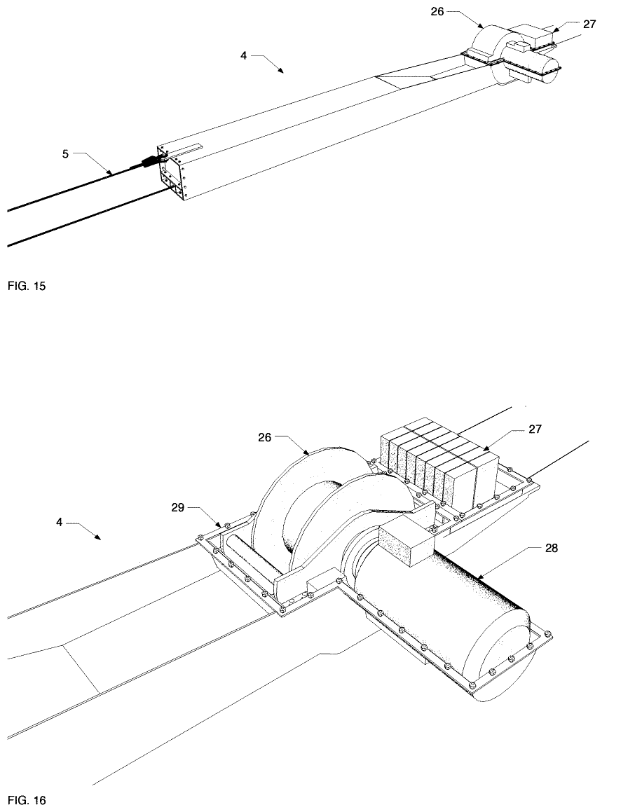

The intended electrical cable connections in the sense of this disclosure can comprise all cable connections necessary for the intended functioning of the solar installation 1. The plurality of solar panels 31 on the frame 30 can be introduced directly from the container into a body of water by a crane system 33 and hanging ropes 32 (FIG. 13), optionally directly from a ship. Making use of the panels' buoyancy, they can then be unfolded by a horizontal force, e.g. with a pull rope 35 and a watercraft 36. The unfolded panels 34 then float on the water surface 12 (FIGS. 12 and 14). The units of interconnected solar panels can then be connected to the pre-installed rope net and to adjacent units. The units can subsequently be connected via electrical cables 7, 8, 9 directly to a central solar charge controller on land or on a floating platform. From there, a voltage converter can provide the connection to the power grid. In this way, a large-area solar installation 1, for example with an output size of more than one megawatt, can be erected in a short time.

Under suitable climatic conditions, the solar installation 1 can be operated at the water surface and, with appropriate solar irradiation, generates electrical energy. An anchoring system can hold the solar installation 1 in position.

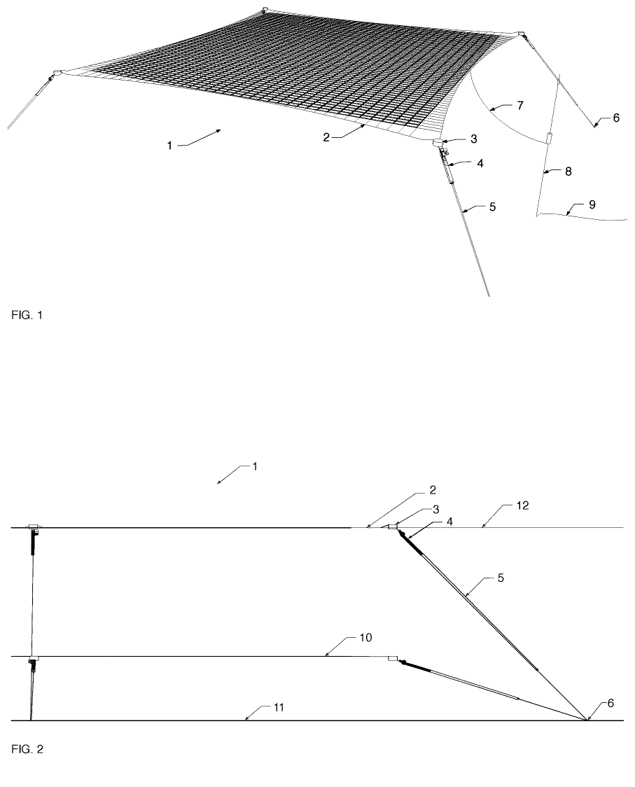

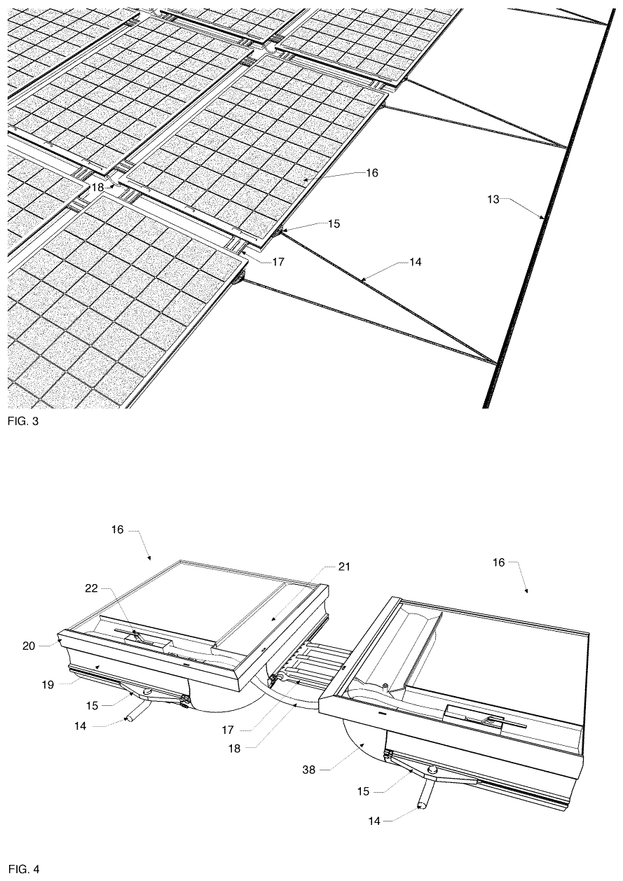

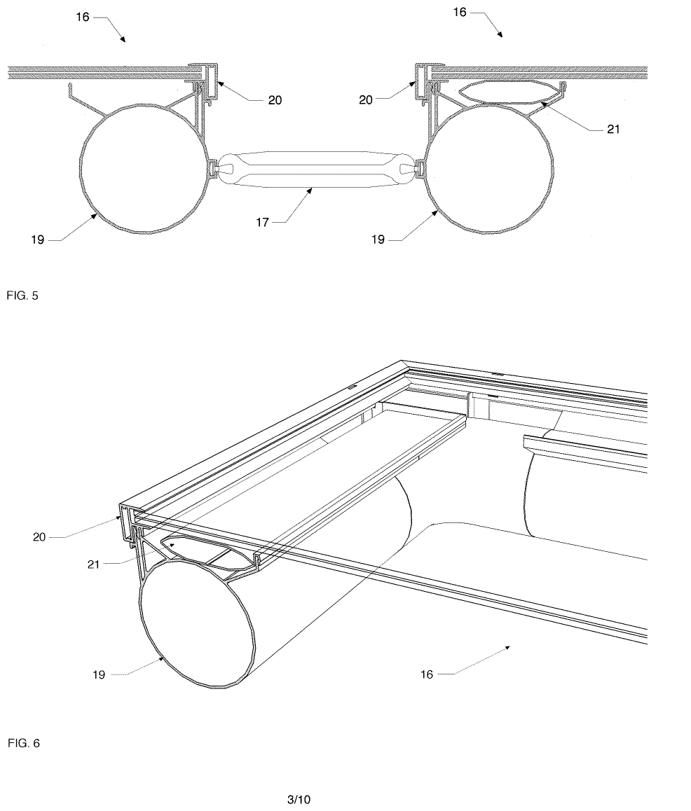

Under critical climatic conditions, optionally with heavy seas, the solar installation 1 can be pulled in the direction of the bottom 11 of the body of water by the diving element 4, optionally comprising a winch 26, and the solar panels can float at a predetermined diving depth 10. FIG. 2 shows, by way of example, a total water depth of thirty meters and a diving depth 10 of the solar installation 1 of twenty meters.

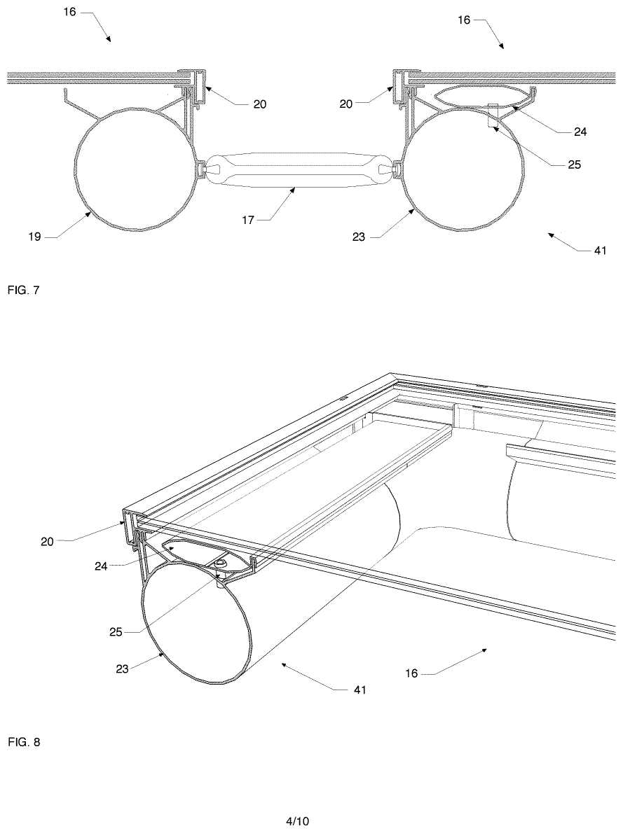

FIG. 7 and FIG. 8 show the detailed construction of individual solar panels with frame and buoyancy body of an exemplary, non-limiting implementation. A glass-glass solar panel 16 can, for example, be framed by a frame 20 made of aluminum, which is force-fit clipped onto a buoyancy body made of aluminum. On three sides of the solar panel, the buoyancy bodies 19 can be implemented as incompressible. On a fourth side of the solar panel, the buoyancy body can be implemented as partially compressible, wherein a compressible portion 24 can be connected via an air-conducting connection 25 to the incompressible portion 23. If the solar module is moved in the direction of the bottom of the body of water, the compressible portion 24 is completely compressed at a predetermined water depth and the buoyant force is reduced such that the solar module can float in the water column.

A flexible connection 17 between the solar panels can, for example, consist of two aluminum parts which can be inserted, for example, into grooves on the buoyancy bodies, and of a middle part that is force-fit connected to the aluminum parts, optionally made of an elastomer, e.g. silicone rubber.

According to a further exemplary, non-limiting implementation, the buoyancy body can be a one-piece partially compressible buoyancy body 37. An exemplary, non-limiting implementation is shown in FIG. 11. A profile can be compressed by the increasing pressure until, for example, a central web touches the opposite side. Thereafter, essentially no further compression can take place up to the intended diving depth.

According to yet a further exemplary, non-limiting implementation, as shown in FIGS. 9 and 10, the solar installation 1 can comprise, for example, a flexible thin-film panel 39 and a flexible reversibly compressible buoyancy body 40. Due to a small negative buoyant force of the solar panel, the incompressible buoyancy body or its portion can be omitted, and nevertheless the solar installation 1 can have positive buoyancy at the surface and neutral buoyancy at the predetermined depth.

Other, exemplary, non-limiting implementations can be combined from parts of the exemplary, non-limiting implementations shown. It is also clear that parts of the solar installation 1 can be integrated into other parts of the solar installation 1, such as, for example, a buoy being integrated into a diving element.

According to a further exemplary, non-limiting implementation, the solar installation 1 is intended for use for the generation of energy.

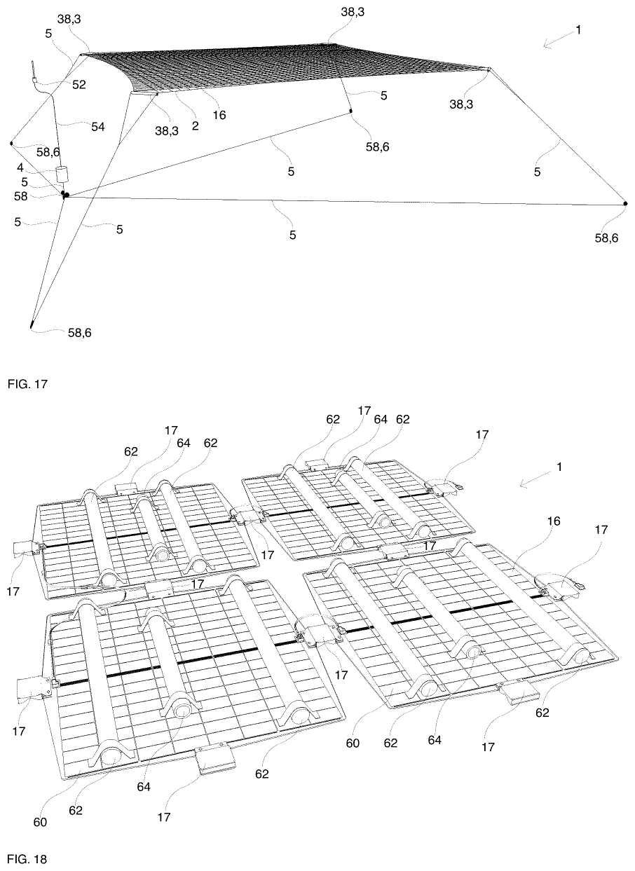

With reference to FIG. 17, a perspective view of an exemplary, non-limiting implementation of the solar installation 1 is shown. Corner connections 38 are provided with second incompressible buoyancy bodies configured as buoys 3. The buoys 3 are designed as elongated, optionally cylindrical, float bodies, wherein the longitudinal ends of each buoy 3 are connected to corners of the rope net. As a result, an improved, optionally uniform, buoyancy of the solar installation 1 is obtained.

The corner connections 38 are each connected via connecting elements designed as steel cables 5 to an incompressible second buoyancy body as diving element 4. Instead of steel cables 5, ropes or textiles made of fibers based on polymers with a high molecular mass of, for example, 10⁶ mol g/mol or more, optionally ultra-high-molecular-weight polyethylene (PE-UHMW) of 2×10⁶ mol g/mol to 6×10⁶ mol g/mol, can also be used. The diving element 4 comprises a pump 52 with a line 54, which connects the diving element 4 to the water surface. The diving element 4 is, for example, designed as a hollow body made of an essentially incompressible material, e.g. aluminum or steel of suitable wall thickness, wherein the volume defined by the hollow body can be filled with water, air or a water-air mixture to provide a desired buoyancy. Instead of a single diving element 4, a plurality of diving element, e.g. 2, 3 or 4 diving element 4, can be provided. The diving element 4 can provide different volumes and be connected to at least one of the corner connections 38.

The steel cables 5 are further connected to the diving element 4 via a pulley or deflection pulley 58 anchored on the bottom of the body of water. In this way, in the case of a local force effect acting, for example, on one of the corner connections 38, caused for example by a wave, a redistribution of the force effect over the diving element 4 to the further corner connections 38 can be achieved. As a result, local forces acting on the solar installation 1, optionally local forces such as waves in a sea state, can be distributed uniformly over the solar installation 1 and damage can be avoided. Furthermore, control electronics that may be susceptible to faults and require maintenance for uniform distribution of the forces to the corner connections 38 can be dispensed with. For example, a vertically upward acting force, optionally a wave, on one of the corner connections 38 generates a tensile force in the steel cable 5 connected thereto and pulls the diving element 4 downward, thereby relieving the other steel cables 5 and the corner connections 38 connected thereto and reducing tension spikes.

With further reference to FIG. 18, a perspective view of a section of an underside 60 of the solar installation 1 according to an exemplary, non-limiting implementation is shown. On the underside 60 of the solar installation 1, two incompressible buoyancy bodies as second buoyancy bodies 62 and one partially reversibly compressible buoyancy body as first buoyancy body 64 are attached to each of the solar panels 16 shown, essentially symmetrically. A connection of the solar panels 16 to one another and to the (not shown, optional) frame 20 is provided via flexible connections 17. As mentioned above, the frame 20 is optional and can be omitted.

The first and second buoyancy bodies 62, 64 are of tubular design and adapted to enable the solar installation 1 to float on a water surface 12. The tubular design allows simple and cost-effective production from simple materials, e.g. aluminum of suitable wall thickness, for the second buoyancy body 62.

The first buoyancy body 64, which provides a reversibly compressible air volume, is adapted to be compressed at a water depth of, for example, 2 m and thus to provide a predetermined positive buoyancy that is lower than at the water surface. The first buoyancy body 64 is in this case configured not to be further compressed at a greater water depth, for example more than 2 m. The second buoyancy bodies 62, which provide a constant incompressible air volume, can provide only a slight buoyancy such that the solar installation 1 can be moved at and below this water depth with reduced energy input by the diving element 4.

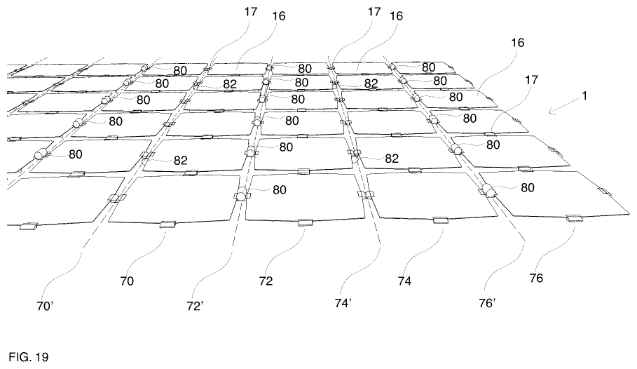

With reference to FIG. 19, a further perspective view of a section of the solar installation 1 according to an exemplary, non-limiting implementation is shown. In the exemplary, non-limiting implementation shown, the solar panels 16 are formed with flexible connecting elements 17 to one another in rows 70, 72, 74, 76, wherein the flexible connecting elements 17, which are likewise arranged in a row 70′, 72′, 74′, 78′, are formed as rotary elements that alternately allow a rotation in opposite directions in such a manner that the rows 70, 72, 74, 76 can be brought congruently according to a Leporello or zigzag fold. This can simplify transport and/or assembly or disassembly of the solar installation 1, for example an unfolding or folding together of the solar installation 1 on the water surface can take place with a small force input or with the aid of a watercraft. For disassembly of the solar installation 1, floats 80 can temporarily be attached to the connecting elements 17 of the rows 72′, 76′, etc., and weights 82 can be attached to the connecting elements 17 of the rows 70′, 74′, etc. With a suitable choice of the buoyant forces of the floats 80 and the weights 82, the solar installation 1 folds together by itself and thus enables a simple and cost-efficient disassembly.

The following describes an exemplary, non-limiting manufacturing route of a solar installation 1 according to the disclosure. A solar installation 1 according to the disclosure can also be obtained by other manufacturing processes.

A solar panel 16 can be laminated from five layers. The layers can be structured as follows: rear glass 3 mm, tempered; POE film; photovoltaic cells; POE film; front glass 3 mm, tempered.

The frame 20 and the incompressible portion of the partially compressible buoyancy body 23 can be produced from saltwater-resistant aluminum by extrusion. Suitable aluminum alloys can be used. The corner connection 38 can be produced by aluminum die casting. Water-tightness and stability can be ensured by O-rings and spot welding or alternatively by full welding. Suitable welding processes such as friction stir welding can be used. For further stabilization, additional aluminum angles can be inserted into the frame 20 as is customary with conventional framed solar panels and in façade construction. The solar panel 16 can, for example, be bonded into the frame 20 with silicone rubber.

The reversibly compressible portion of the partially compressible buoyancy body can be produced, for example, from polypropylene by extrusion. The ends can be sealed to be water-tight by heat sealing. The air-conducting connection 25 between the two parts of the partially compressible buoyancy body can be produced by an annular snap connection with integrated O-rings.

A flexible connection 17 between the panels can comprise or consist of two aluminum die-cast parts which are overmolded in the center with elastic silicone rubber in an injection-molding process to form a force-fit. The geometry of the aluminum part can be adapted such that it can be inserted into the groove in the frame profile and clipped in. Alternative fastening types may be used.

A fastening element 15 can likewise be produced by aluminum die casting. The geometry can likewise be adapted such that it can be inserted into the groove in the frame profile and clipped in.

The required electrical connections 18 can be implemented by saltwater-resistant cables. The junction box 22 with the electrical connections can be potted with saltwater-resistant potting compound.

A rope net 2 can be made from ropes suitable for this purpose, optionally made of synthetic fibers.

A buoy at the corner point of the solar installation 1 can be a simple steel construction. It can contain a partially compressible and partially incompressible buoyancy body, whereby the buoyancy at the surface and at depth can be predetermined by the calculation methods described above.

A compressible buoyancy body in the sense of this disclosure can always also be implemented by way of an air space that is open downward, similar to the principle of a diving bell.

A diving element 4 can be designed as a winch system and can be flexibly attached to the buoy by ropes. It can comprise or consist of a standard winch for steel cables with a steel housing for protection. The steel housing can be open toward the bottom of the body of water and thus remain dry. The air pressure in the winch system can thereby adapt to the ambient pressure. The winch system can be operated by rechargeable batteries 27, e.g. LiFePO batteries, which can be charged by the solar panels 16. Control can be carried out via sonar transponders or via cable connections.

An anchoring 6 on the bottom of the body of water can, in the case of a sandy bottom, be implemented by screw anchors. These and alternative anchoring methods can be used.

All materials can optionally be selected such that they can be completely recycled after the planned service period.

Cleaning of soiling and algae growth on the upper side of the solar panels can be carried out manually or e.g. with commercially available semi-automatic or fully automatic cleaning robots for solar panels. For example, semi-automatic or fully automatic cleaning robots for swimming pools can also be used. The cleaning robots can be operated by batteries which in turn can be charged with solar power.

On the underside of the solar panels and the buoyancy bodies, algae, barnacle and mussel growth is to be expected, which in the long term can lead to a reduction in buoyancy. The growth is optionally not removed. By small subsequently attached buoyancy bodies, the calculated ideal buoyancy behavior can be restored and interval-based cleaning of the underside of the solar panels can be dispensed with.

The present disclosure further comprises the examples listed below:

Example 1. Disclosed is a submersible solar installation, comprising: a solar panel; at least one buoyancy body connected to the solar panel; wherein the solar panel and the at least one buoyancy body have positive buoyancy at a water surface of a body of water; and a diving element adapted to subject the submersible solar installation to a negative buoyant force; wherein the at least one buoyancy body comprises a first buoyancy body that is at least partially reversibly compressible.

Example 2. Optionally, the at least one buoyancy body comprises an incompressible second buoyancy body.

Example 3. Optionally, the at least one buoyancy body forms a frame structure that at least partially surrounds the solar panel.

Example 4. Optionally, the solar panel comprises a plurality of solar panels and flexible connecting elements, wherein the plurality of solar panels are interconnected via the flexible connecting elements.

Example 5. Optionally, the at least one buoyancy body is configured as a flexible connecting element.

Example 6. Optionally, the plurality of solar panels are arranged in several rows, wherein the several rows comprise a first row and an adjacent second row, wherein flexible connecting elements arranged between the first row and the second row comprise a hinge such that the second row can be brought substantially congruently onto the first row.

Example 6. Optionally, the solar installation comprises a connecting element, e.g. a rope net, that is connected to the at least one buoyancy body and the diving element.

Example 7. Optionally, a force exerted by the diving element acts substantially uniformly on the at least one buoyancy body.

Example 8. Optionally, the diving element comprises a pulling system; wherein the pulling system is attached at several, e.g. four or more, attachment points to the at least one buoyancy body; wherein the pulling system is adapted to pull the solar panel and the at least one buoyancy body to a predetermined diving depth.

Example 9. Optionally, the pulling system comprises an anchoring that is fixed to a bottom of the body of water.

Example 10. Optionally, the pulling system comprises at least one incompressible buoyancy body, several connecting element, and at least one pulley, via which the several connecting elements are guided, wherein the several connecting elements respectively connect one of the several attachment points with at least one of the at least one incompressible buoyancy bodies, and optionally with another of the one or several attachment points, in such a manner that a force acting on a particular attachment point and/or on the incompressible buoyancy body can be distributed to the further attachment points and/or to the at least one incompressible buoyancy body, optionally wherein the at least one pulley is fixed to a bottom of the body of water.

Example 11. Optionally, the at least one pulley is fixed to a bottom of the body of water.

Example 12. Disclosed is a use of the present submersible solar installation for generating electrical energy.

Example 13. Disclosed is a transport system for the present submersible solar installation, comprising a container; and a plurality of solar panels; wherein the plurality of solar panels are interconnected via flexible connecting elements, wherein the flexible connecting elements are adapted to reversibly transfer the plurality of solar panels from a flat first state into a folded second state, wherein in the second state at least several of the plurality of solar panels are positioned on top of each other in such a manner that accommodation of the plurality of solar panels in the container is enabled.

Example 14. Optionally, the transport system comprises a frame that is connected to the plurality of solar panels in such a manner that the plurality of solar panels can be transferred from the second state to the first state and/or from the first state to the second state by application of a force to the frame.

Example 15. Disclosed is a use of the present transport system for transporting the present submersible solar installation.

What is claimed is:

1. A submersible solar installation, comprising:
a solar panel;
at least one buoyancy body connected to the solar panel; wherein the solar panel and the at least one buoyancy body are designed to have a positive buoyancy at a water surface of a body of water; and
a diving element adapted to subject the submersible solar installation to a negative buoyant force;
wherein the at least one buoyancy body includes a first buoyancy body that is at least partially reversibly compressible.

2. The submersible solar installation according to claim 1; wherein the at least one buoyancy body includes an incompressible second buoyancy body.

3. The submersible solar installation according to claim 1; wherein the at least one buoyancy body forms a frame structure that at least partially surrounds the solar panel.

4. The submersible solar installation according to claim 1, comprising a further solar panel and a flexible connecting element, wherein the solar panel and the further solar panel are interconnected via the flexible connecting element.

5. The submersible solar installation according to claim 4, wherein the at least one buoyancy body is configured as the flexible connecting element.

6. The submersible solar installation according to claim 4, wherein the solar panel is arranged in a first row and the further solar panel is arranged in a second row adjacent to the first row, wherein the flexible connecting element is arranged between the first row and the second row and includes a hinge such that the second row can be brought substantially congruently onto the first row.

7. The submersible solar installation according to claim 1, comprising a connecting element, which is connected to the at least one buoyancy body and the diving element.

8. The submersible solar installation according to claim 1, wherein a force exerted by the diving element acts substantially uniformly on the at least one buoyancy body.

9. The submersible solar installation according to claim 1, wherein the diving element includes a pulling system; wherein the pulling system is attached at several attachment points to the at least one buoyancy body, wherein the pulling system is adapted to pull the solar panel and the at least one buoyancy body to a predetermined diving depth.

10. The submersible solar installation according to claim 9, wherein the pulling system includes an anchoring designed to be fixed to a bottom of the body of water.

11. The submersible solar installation according to claim 9, wherein the pulling system includes at least one incompressible buoyancy body, several connecting elements, and at least one pulley over which the several connecting elements are guided, wherein the several connecting elements respectively connect one of the several attachment points with the at least one incompressible buoyancy body in such a manner that a force acting on the attachment point and/or the at least one incompressible buoyancy body is distributed to a further attachment point and/or the at least one incompressible buoyancy body.

12. The submersible solar installation according to claim 11, wherein the at least one pulley is designed to be fixed to a bottom of the body of water.

13. A method, comprising providing the submersible solar installation according to claim 1 and generating electrical energy using the submersible solar installation.

14. A transport system for the submersible solar installation according to claim 1, comprising:
a container; and
a plurality of solar panels;
wherein the plurality of solar panels are interconnected via flexible connecting elements, wherein the flexible connecting elements are adapted to reversibly transfer the plurality of solar panels from a flat first state into a folded second state, wherein in the folded second state at least several of the plurality of solar panels are positioned on top of each other in such a manner that accommodation of the plurality of solar panels in the container is enabled.

15. The transport system according to claim 14, comprising a frame connected to the plurality of solar panels in such a manner that the plurality of solar panels are transferrable from the folded second state to the flat first state and/or from the flat first state to the folded second state by application of a force to the frame.

16. A method, comprising providing the transport system according to claim 14 for transporting the submersible solar installation according to claim 1.
